(19) United States
(12) Patent Application Publication
(10) Pub. No.: US 2019/0084580 A1
(43) Pub. Date: Mar. 21, 2019

(54) COMMUNICATION SYSTEM

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Yuichi Kodama, Yokkachi, Mie (JP); Takeshi Fujimoto, Yokkachi, Mie (JP); Satoshi Horihata, Yokkachi, Mie (JP); Hiroshi Ueda, Yokkachi, Mie (JP); Tomohiro Mizutani, Yokkaichi, Mie (JP); Yoshiaki Matsutani, Yokkachi, Mie (JP); Masakatsu Moriguchi, Yokkachi, Mie (JP); Akihiro Natsume, Yokkachi, Mie (JP); Tomoyuki Mishima, Yokkachi, Mie (JP); Hideaki Tsuriya, Yokkachi, Mie (JP)

(21) Appl. No.: 15/758,980

(22) PCT Filed: Sep. 7, 2016
(86) PCT No.: PCT/JP2016/076269

§ 371 Date: Mar. 9, 2018

(30) Foreign Application Priority Data
Sep. 14, 2015 (JP) 2015-181021

(51) Int. Cl. B60W 50/02; H04W 12/06; H04L 29/06; B60R 16/023; H04L 12/46

(52) U.S. Cl. CPC B60W 50/0205; H04W 12/06; H04L 63/0428; B60R 16/023; H04L 12/46; H04L 63/08

(57) ABSTRACT

In a communication system, an in-vehicle relay device relays data between ECUs, which are each connected to a communication line in a vehicle, by communicating with each of the ECUs. Data received by a communication device from a server outside the vehicle is input to an out-of-vehicle relay device. Data to be transmitted by the communication device to the server is output to the communication device by the out-of-vehicle relay device. The out-of-vehicle relay device relays data between the server and the ECUs by passing data to and from the in-vehicle relay device. The out-of-vehicle relay device outputs, to the in-vehicle relay device, data input to the out-of-vehicle relay device, or associated data that is associated with data that was output. The in-vehicle relay device determines whether the relaying performed by the out-of-vehicle relay device is to be suspended, based on associated data output by the out-of-vehicle relay device.

### CROSS-REFERENCE TO RELATED APPLICATIONS

This application is the U.S. national stage of PCT/JP2016/076269 filed Sep. 7, 2016 which claims priority of Japanese Patent Application No. JP 2015-181021 filed Sep. 9, 2015.

### TECHNICAL FIELD

The present invention relates to a communication system in which data is relayed.

### BACKGROUND

Currently, communication systems are prevalent in which data is relayed between ECUs (Electronic Control Units) that are each connected to one of multiple communication lines in a vehicle (e.g., see JP 2014-193654A). Each ECU controls the operation of electrical devices that are connected to the ECU. Control processing for coordinating multiple electrical devices is realized by communication between the ECUs.

In the communication system described in JP 2014-193654A, data is also relayed between the ECUs and an external apparatus that is disposed outside of the vehicle. The ECUs can thus acquire various types of data from the external apparatus.

In conventional communication systems such as that described in JP 2014-193654A, in order to prevent the relaying of unsuitable data received from an external apparatus, various types of data processing are performed on the data, and it is checked whether the data is legitimate data. For example, an authentication code is generated using the data and an encryption key, and it is determined whether or not the generated authentication code matches an authentication code that was transmitted along with the data. If the generated authentication code matches the authentication code that was transmitted along with the data, it is confirmed that the received data is legitimate data.

However, there is a possibility that unsuitable data will be mistakenly confirmed to be legitimate data, and consequently the relaying apparatus that relays the data will perform incorrect processing. Also, even if unsuitable data is correctly confirmed to not be legitimate data through the data processing, there is a possibility that the unsuitable data will be successively transmitted at short time intervals, and a malfunction will occur. Moreover, once a program in the relaying apparatus for transmitting data to an external apparatus is tampered with such that important confidential data is transmitted to an external apparatus, the transmission of important data cannot be controlled through data processing.

The present invention was achieved in light of the foregoing circumstances, and an object of the present invention is to provide a communication system that can suppress the occurrence of a problem that cannot be handled through data processing.

### SUMMARY

A communication system according to an aspect of the present invention is a communication system including an internal relay device that relays data between a plurality of communication apparatuses installed in a vehicle by communicating with each of the plurality of communication apparatuses, the communication system including: an external relay device that relays data between the communication apparatuses and an external apparatus that is outside the vehicle by passing data to and from the internal relay device, wherein the external relay device has an input unit to which data received from the external apparatus is input, an output unit that outputs data that is to be transmitted to the external apparatus, and a second output unit that outputs, to the internal relay device, associated data that is associated with the data that was output by the output unit, and the internal relay device has a determination unit that determines whether or not relaying performed by the external relay device is to be suspended, based on the associated data that was output by the second output unit.

In the present invention, the internal relay device relays data between the communication apparatuses installed in the vehicle by communicating with each of the communication apparatuses. Data that is received from the external apparatus that is outside the vehicle is input to the external relay device. The external relay device outputs data that is to be transmitted to the external apparatus. The external relay device relays data between the external apparatus and the communication apparatus by passing data to and from the internal relay device. The external relay device outputs, to the internal relay device, the associated data that is associated with the data that was output. The internal relay device determines whether or not the relaying performed by the external relay device is to be suspended based on the associated data that was output by the external relay device.

For this reason, it is possible to suppress the occurrence of a problem that cannot be handled by data processing performed on data that was output from the external relay device.

A communication system according to an aspect of the present invention is a communication system including an internal relay device that relays data between a plurality of communication apparatuses installed in a vehicle by communicating with each of the plurality of communication apparatuses, the communication system including: an external relay device that relays data between the communication apparatuses and an external apparatus that is outside the vehicle by passing data to and from the internal relay device, wherein the external relay device has an input unit to which data received from the external apparatus is input, an output unit that outputs data that is to be transmitted to the external apparatus, a second output unit that outputs, to the internal relay device, associated data that is associated with the data that was input to the input unit, and an authentication unit that performs authentication on the data that was input to the input unit, the internal relay device has a determination unit that determines whether or not relaying performed by the external relay device is to be suspended, based on the associated data that was output by the second output unit, the associated data includes information regarding failure or success of authentication performed by the authentication unit, and the determination unit determines that the relaying is to be suspended in a case where the number of times that authentication performed by the authentication unit failed is greater than or equal to a predetermined failure count, or where the number of times that authentication performed by the authentication unit was successful is greater than or equal to a predetermined success count.

In the present invention, the internal relay device relays data between the communication apparatuses installed in the vehicle by communicating with each of the communication apparatuses. Data that is received from the external apparatus that is outside the vehicle is input to the external relay device. The external relay device outputs data that is to be transmitted to the external apparatus. The external relay device relays data between the external apparatus and the communication apparatus by passing data to and from the internal relay device. The external relay device outputs, to the internal relay device, the associated data that is associated with the data that was input. The internal relay device determines whether or not the relaying performed by the external relay device is to be suspended based on the associated data that was output by the external relay device. For this reason, it is possible to suppress the occurrence of a problem that cannot be handled by data processing performed on data that was input to the external relay device. The external relay device performs authentication on the data that was input, and the associated data includes information regarding failure or success of the authentication performed by the external relay device. Based on the associated data, the relaying performed by the external relay device is suspended if the number of times that authentication failed in a certain time is greater than or equal to the predetermined failure count, or if the number of times that authentication was successful in a certain time is greater than or equal to the predetermined success count.

If the number of authentication failures is large, there is a possibility that, for example, data and authentication codes generated from the data with use of various encryption keys are being repeatedly transmitted in order to search for an encryption key that will be successfully authenticated. If the number of authentication failures in a certain time is greater than or equal to the predetermined failure count, the relaying performed by the external relay device is suspended, thus preemptively preventing unsuitable data from being relayed.

Also, authentication normally fails a certain percentage of the time, and therefore a large number of authentication successes in a certain time is unnatural and indicates a possibility that a program for authentication has been manipulated. Suspending the relaying performed by the external relay device suppresses the occurrence of a problem caused by a manipulated program.

A communication system according to an aspect of the present invention is a communication system including an internal relay device that relays data between a plurality of communication apparatuses installed in a vehicle by communicating with each of the plurality of communication apparatuses, the communication system including: an external relay device that relays data between the communication apparatuses and an external apparatus that is outside the vehicle by passing data to and from the internal relay device, wherein the external relay device has an input unit to which data received from the external apparatus is input, an output unit that outputs data that is to be transmitted to the external apparatus, and a second output unit that outputs, to the internal relay device, associated data that is associated with the data that was input to the input unit, the internal relay device has a determination unit that determines whether or not relaying performed by the external relay device is to be suspended, based on the associated data that was output by the second output unit, the associated data includes information regarding an amount of data that was input to the input unit, and the determination unit determines that the relaying is to be suspended in a case where the amount of data that was input to the input unit is greater than or equal to a predetermined input data amount.

In the present invention, the internal relay device relays data between the communication apparatuses installed in the vehicle by communicating with each of the communication apparatuses. Data that is received from the external apparatus that is outside the vehicle is input to the external relay device. The external relay device outputs data that is to be transmitted to the external apparatus. The external relay device relays data between the external apparatus and the communication apparatus by passing data to and from the internal relay device. The external relay device outputs, to the internal relay device, the associated data that is associated with the data that was input. The internal relay device determines whether or not the relaying performed by the external relay device is to be suspended based on the associated data that was output by the external relay device. For this reason, it is possible to suppress the occurrence of a problem that cannot be handled by data processing performed on data that was input to the external relay device.

Based on the associated data that includes information regarding the amount of data that was input to the external relay device, the relaying performed by the external relay device is suspended if the amount of data that was input to the external relay device in a certain time is greater than or equal to the predetermined input data amount.

If a large amount of data is input in a certain time, there is a possibility that unsuitable data is being successively transmitted at short time intervals. By suspending the relaying performed by the external relay device, it is possible to stop the input of unsuitable data.

In the communication system according to an aspect of the present invention, the associated data includes information regarding an amount of data that was output by the output unit, and the determination unit determines that the relaying is to be suspended in a case where the amount of data that was output by the output unit is greater than or equal to a predetermined output data amount.

In the present invention, based on the associated data that includes information regarding the amount of data that was output by the external relay device, the relaying performed by the external relay device is suspended if the amount of data that was output by the external relay device in a certain time is greater than or equal to the predetermined output data amount.

If a large amount of data is output in a certain time, there is a possibility that the program for outputting data has been manipulated. By suspending the relaying performed by the external relay device, it is possible to stop the leakage of data.

In the communication system according to an aspect of the present invention, the associated data includes information regarding content of the data that was output by the output unit, and the determination unit determines that the relaying is to be suspended in a case where specific data was output from the output unit.

In the present invention, based on the associated data that includes information indicating the content of the data that was output by the external relay device, the relaying performed by the external relay device is suspended if the data that was output by the external relay device is specific data.

This specific data is data that should not be output to the outside, for example. Accordingly, the output of the specific data indicates a possibility that the program for outputting data has been manipulated. By suspending the relaying performed by the external relay device, it is possible to stop the leakage of the specific data.

In the communication system according to an aspect of the present invention, the internal relay device has a power supply stopping unit that stops a supply of power to the external relay device in a case where the determination unit determined that the relaying performed by the external relay device is to be suspended.

In the present invention, the relaying performed by the external relay device is reliably suspended by stopping the supply of power to the external relay device.

In the communication system according to an aspect of the present invention, the internal relay device has a prohibiting unit that prohibits inputting of data from the external apparatus to the input unit and outputting of data from the output unit to the external apparatus in a case where the determination unit determined that the relaying performed by the external relay device is to be suspended.

In the present invention, the relaying performed by the external relay device is reliably suspended by prohibiting the input of data from the external apparatus to the external relay device and the output of data from the external relay device to the external apparatus.

In the communication system according to an aspect of the present invention, the external relay device relays data between the external apparatus and a second communication apparatus.

In the present invention, by passing data to and from the internal relay device, the external relay device relays data between the external apparatus and the communication apparatus, and also relays data between the external apparatus and the second communication apparatus.

According to the present invention, it is possible to suppress the occurrence of a problem that cannot be handled through data processing.

### BRIEF DESCRIPTION OF DRAWINGS

FIG. 1 is a block diagram showing a configuration of relevant portions of a communication system according to a first embodiment.

FIG. 2 is a block diagram showing a configuration of relevant portions of a gateway.

FIG. 3 is an illustrative diagram of storage regions of a storage unit in an out-of-vehicle relay device.

FIG. 4 is a flowchart showing a procedure of server data storage processing that is executed by a control unit of the out-of-vehicle relay device.

FIG. 5 is a flowchart showing a procedure of vehicle data output processing that is executed by the control unit of the out-of-vehicle relay device.

FIG. 6 is a flowchart showing a procedure of server transmission request data output processing that is executed by the control unit of the out-of-vehicle relay device.

FIG. 7 is an illustrative diagram of storage regions of a storage unit in an in-vehicle relay device.

FIG. 8 is a table showing an example of associated data information stored in an associated data region.

FIG. 9 is a flowchart showing a procedure of first ECU data storage processing that is executed by a control unit of the in-vehicle relay device.

FIG. 10 is a flowchart showing a procedure of relay suspend processing that is executed by the control unit of the in-vehicle relay device.

FIG. 11 is a table showing determination standards for determining whether or not relaying performed by the out-of-vehicle relay device is to be suspended.

FIG. 12 is a block diagram showing a configuration of relevant portions of a gateway according to a second embodiment.

FIG. 13 is a block diagram showing a configuration of relevant portions of a communication system according to a third embodiment.

FIG. 14 is a block diagram showing a configuration of relevant portions of a communication system according to a fourth embodiment.

### DETAILED DESCRIPTION OF PREFERRED EMBODIMENTS

Hereinafter, the present invention will be described in detail with reference to drawings that illustrate embodiments of the present invention.

### First Embodiment

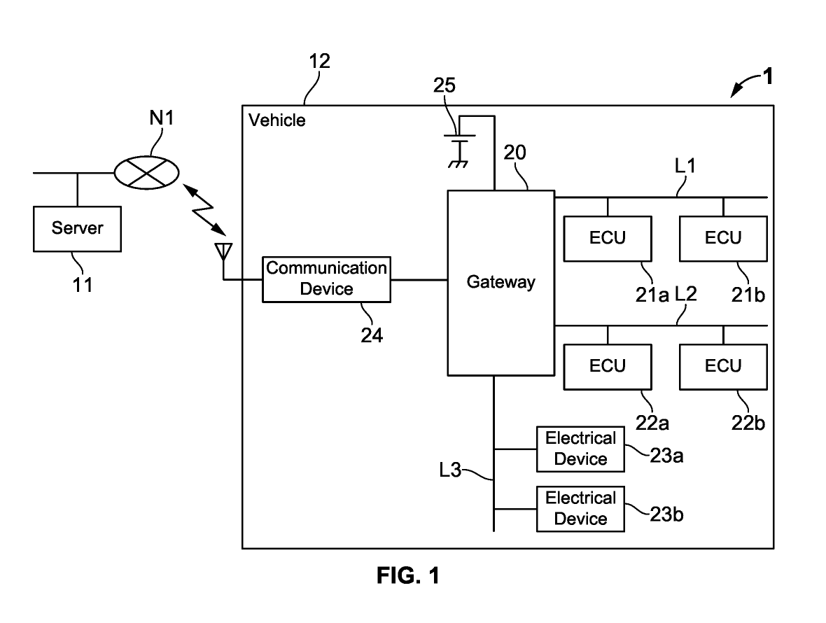

FIG. 1 is a block diagram showing the configuration of relevant portions of a communication system 1 of a first embodiment. The communication system 1 includes a server 11 and a vehicle 12. The server 11 is outside the vehicle 12, and communicates with the vehicle 12 via a network Ni. The server 11 transmits data to the vehicle 12. Hereinafter, data transmitted by the server 11 to the vehicle 12 will be referred to as server data.

The server 11 receives server transmission request data from the vehicle 12 via the network Ni, and this data is data for requesting the server 11 to transmit data to the vehicle 12. The server transmission request data includes information that indicates the server data that is to be transmitted by the server 11. Upon receiving the server transmission request data, the server 11 transmits the server data that is indicated by the information included in the server transmission request data.

The server 11 also transmits vehicle transmission request data to the vehicle 12 via the network Ni, and this data is data for requesting the vehicle 12 to transmit vehicle data regarding the vehicle 12 to the server 11. The vehicle data indicates the position of the vehicle 12, the brake pedal position, and the like. The vehicle transmission request data includes information that indicates the vehicle data that is to be transmitted to the server 11. Upon receiving the vehicle transmission request data, the vehicle 12 transmits the vehicle data that is indicated by the information included in the received vehicle transmission request data, to the server 11 via the network Ni. The server 11 receives the vehicle data from the vehicle 12.

The server 11 and the vehicle 12 each store a shared encryption key. The encryption key is a string of numbers, for example. When server data is to be transmitted, the server 11 generates an authentication code with use of the server data and the encryption key. The server 11 transmits the authentication code generated from the server data to the vehicle 12 along with the server data. Similarly, when vehicle transmission request data is to be transmitted, the server 11 generates an authentication code with use of the vehicle transmission request data and the encryption key. The server 11 transmits the authentication code generated from the vehicle transmission request data to the vehicle 12 along with the vehicle transmission request data.

The vehicle 12 performs authentication on the server data and the vehicle transmission request data that are received from the server 11. Specifically, the vehicle 12 generates an authentication code with use of the encryption key and the data that was received from the server 11, and determines whether or not the generated authentication code matches the authentication code that was received from the server 11. If it is determined that the generated authentication code and the received authentication code match each other, the vehicle 12 determines that the authentication was successful, and if it is determined that the generated authentication code and the received authentication code do not match each other, the vehicle 12 determines that the authentication failed.

The vehicle 12 has a gateway 20, ECUs 21a, 21b, 22a, and 22b, electrical devices 23a and 23b, a communication device 24, a battery 25, and communication lines L1, L2, and L3. The gateway 20 is connected to the communication device 24, the positive terminal of the battery 25, and each of the communication lines L1, L2, and L3. The negative terminal of the battery 25 is grounded. The ECUs 21a and 21b are each connected to the communication line L1. The ECUs 22a and 22b are each connected to the communication line L2. The electrical devices 23a and 23b are each connected to the communication line L3.

The communication device 24 receives server data and vehicle transmission request data from the server 11 via the network Ni. At this time, the communication device 24 receives an authentication code along with the server data or the vehicle transmission request data. Upon receiving server data or vehicle transmission request data from the server 11, the communication device 24 outputs the received data to the gateway 20 along with the authentication code.

The communication device 24 also receives server transmission request data and vehicle data from the gateway 20. Upon receiving server transmission request data or vehicle data, the communication device 24 transmits the received data to the server 11 via the network Ni.

The gateway 20 receives server data and vehicle transmission request data from the communication device 24. At this time, an authentication code is input to the gateway 20 along with the server data or the vehicle transmission request data. The previously-mentioned encryption key is stored in the gateway 20. Upon receiving server data or vehicle transmission request data, the gateway 20 performs authentication as previously described with use of the encryption key and the authentication code that was received along with the data.

The gateway 20 transmits successfully authenticated server data to at least one of the electrical devices 23a and 23b or at least one of the ECUs 21a, 21b, 22a, and 22b.

At this time, the gateway 20 transmits the server data as device data to at least one of the electrical devices 23a and 23b. This device data is data that is transmitted to the electrical devices 23a and 23b.

The gateway 20 also transmits the server data as ECU data to at least one of the ECUs 21a, 21b, 22a, and 22b. This ECU data is data that transmitted or received by the ECUs 21a, 21b, 22a, and 22b.

As described above, the gateway 20 relays data that is from the server 11 and bound for the electrical devices 23a and 23b, and relays data that is from the server 11 and bound for the ECUs 21a, 21b, 22a, and 22b.

Also, the gateway 20 receives, via the communication line L1, ECU data transmitted by the ECUs 21a and 21b, and receives, via the communication line L2, ECU data transmitted by the ECUs 22a and 22b. If the authentication of the vehicle transmission request data received from the communication device 24 is successful, the gateway 20 outputs the received ECU data to the communication device 24 as vehicle data. As previously described, the communication device 24 transmits vehicle data received from the gateway 20 to the server 11. In this way, the gateway 20 relays data that is from the ECUs 21a, 21b, 22a, and 22b and bound for the server 11.

Furthermore, the gateway 20 receives server transmission request data from each of the electrical devices 23a and 23b. Upon receiving server transmission request data from either one of the electrical devices 23a and 23b, the gateway 20 outputs the server transmission request data to the communication device 24. As previously described, the communication device 24 transmits server transmission request data received from the gateway 20 to the server 11. In this way, the gateway 20 relays data that is from the electrical device 23a and 23b and bound for the server 11.

The gateway 20 also transmits ECU data received from either one of the ECUs 21a and 21b to the ECUs 22a and 22b, and transmits ECU data received from either one of the ECUs 22a and 22b to the ECUs 21a and 21b. In this way, the gateway 20 relays data between the ECUs 21a, 21b, 22a, and 22b by communicating with the ECUs 21a, 21b, 22a, and 22b.

The gateway 20 receives power from the battery 25. The gateway 20 executes various types of processing with use of the supplied power.

ECU data is exchanged between the ECUs 21a, 21b, 22a, and 22b. The gateway 20 and the ECUs 21a and 21b communicate with each other via the communication line L1. The gateway 20 and the ECUs 22a and 22b communicate with each other via the communication line L2. Communication over the communication lines L1 and L2 is performed in accordance with the CAN (Controller Area Network) protocol, CAN-FD (Controller Area Network with Flexible Data rate), or the like. At least one of the ECUs 21a and 21b exchanges ECU data with at least one of the ECUs 22a and 22b via the gateway 20.

Vehicle-mounted devices (not shown) are connected to each of the ECUs 21a, 21b, 22a, and 22b. The ECUs 21a, 21b, 22a, and 22b control the operation of the vehicle-mounted devices connected thereto based on received ECU data and/or data acquired from sensors (not shown). Examples of the ECU data include data that indicates the speed of the vehicle 12 and data that indicates the position of the brake pedal. These pieces of data are acquired from sensors by one of the ECUs 21a, 21b, 22a, and 22b, for example.

Data that is transmitted by the gateway 20 or either of the ECUs 21a and 21b via the communication line L1 is received by all of the apparatuses that are connected to the communication line L1. Similarly, data that is transmitted by the gateway 20 or either of the ECUs 22a and 22b via the communication line L2 is received by the all of the apparatuses that are connected to the communication line L2.

Unique identification information is assigned to each of the ECUs 21a, 21b, 22a, and 22b. The ECUs 21a, 21b, 22a, and 22b each transmit ECU data that includes the identification information assigned thereto via the communication line L1 or L2.

Upon receiving ECU data from either one of the communication lines L1 and L2, the gateway 20 determines whether the received ECU data is to be relayed, based on the identification information included in the ECU data. Upon determining that the ECU data is to be relayed, the gateway 20 stores the received ECU data and transmits the stored ECU data to the other one of the communication lines L1 and L2.

Upon receiving ECU data, the ECUs 21a, 21b, 22a, and 22b determine whether or not the received ECU data is to be accepted, based on the identification information included in the received ECU data. Upon determining that the received ECU data is to be accepted, the ECUs 21a, 21b, 22a, and 22b control the operation of in-vehicle device connected to the ECU, based on the received ECU data. Upon determining that the received ECU data is not to be accepted, the ECUs 21a, 21b, 22a, and 22b discard the received ECU data.

The electrical devices 23a and 23b are a car navigation system, an audio device, or the like, and receive device data from the gateway 20. Upon receiving device data, the electrical devices 23a and 23b perform various types of processing in accordance with the received device data.

If the electrical device 23a is a car navigation system, for example, the electrical device 23a receives, from the gateway 20, device data that includes path information indicating a path that is to be displayed along with a map on a display unit (not shown). Upon receiving this device data, the electrical device 23a displays the path indicated by the path information included in the received device data on the display unit along with a map.

If the electrical device 23b is an audio device, for example, the electrical device 23b receives audio-related device data from the gateway 20. Upon receiving this device data, the electrical device 23b outputs audio in accordance with the received device data.

The electrical devices 23a and 23b transmit server transmission request data to the gateway 20 via the communication line L3 in order to receive device data. As previously described, upon receiving server transmission request data, the gateway 20 outputs the server transmission request data to the communication device 24. The communication device 24 transmits the server transmission request data to the server 11. Thereafter, server data transmitted from the server 11 to the communication device 24 is transmitted as device data to the transmission source of the server transmission request data via the gateway 20.

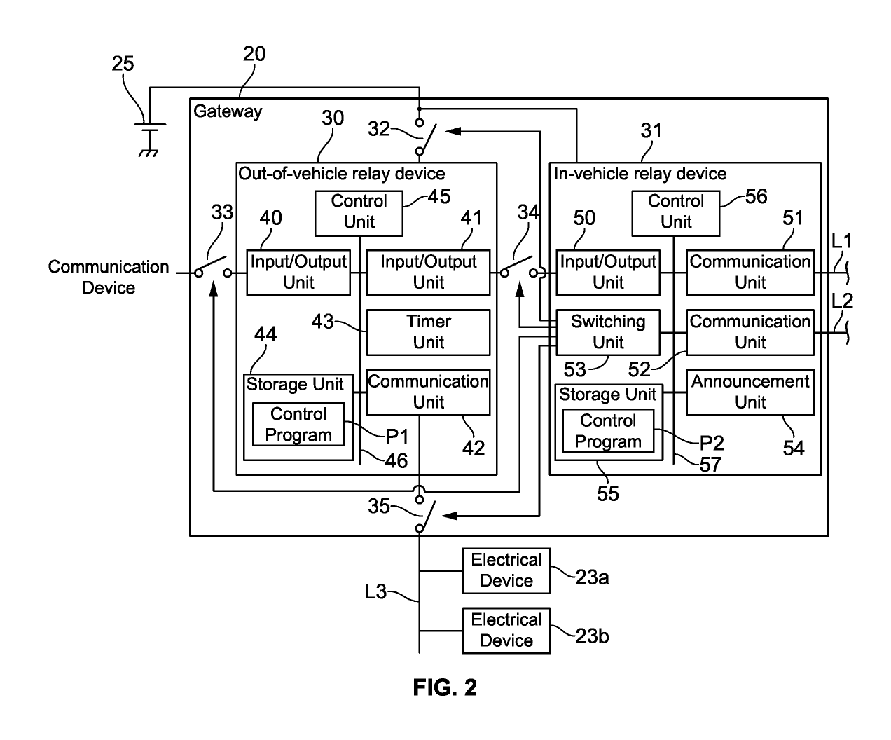

FIG. 2 is a block diagram showing the configuration of relevant portions of the gateway 20. The gateway 20 has an out-of-vehicle relay device 30, an in-vehicle relay device 31, and switches 32, 33, 34, and 35. The positive terminal of the battery 25 is connected to the in-vehicle relay device 31 and one end of the switch 32. The other end of the switch 32 is connected to the out-of-vehicle relay device 30. The out-of-vehicle relay device 30 is further connected to one end of each of the switches 33 and 34. The other end of the switch 33 is connected to the communication device 24. The other end of the switch 34 is connected to the in-vehicle relay device 31. The out-of-vehicle relay device 30 is further connected to the communication line L3. The switch 35 is provided at a midpoint along the communication line L3, and the out-of-vehicle relay device 30 is connected to the electrical device 23a and 23b via the switch 35. The in-vehicle relay device 31 is further connected to each of the communication lines L1 and L2.

The on and off states of the switches 32, 33, 34, and 35 are individually switched by the in-vehicle relay device 31. The in-vehicle relay device 31 receives power from the battery 25. The in-vehicle relay device 31 operates using this power. The out-of-vehicle relay device 30 receives power from the battery 25 via the switch 32. When the switch 32 is on, the out-of-vehicle relay device 30 operates, and when the switch 32 is off, the supply of power from the battery 25 to the out-of-vehicle relay device 30 is interrupted, and thus the out-of-vehicle relay device 30 stops operating.

The out-of-vehicle relay device 30 receives server data and vehicle transmission request data from the communication device 24 via the switch 33. At this time, an authentication code is received along with the server data or the vehicle transmission request data. The previously-mentioned encryption key is stored in the out-of-vehicle relay device 30. Upon receiving server data or vehicle transmission request data, the out-of-vehicle relay device 30 performs authentication as previously described with use of the encryption key and the authentication code that was received along with the data.

The out-of-vehicle relay device 30 determines whether successfully authenticated server data is to be transmitted as device data via the communication line L3, or whether successfully authenticated server data is to be transmitted as ECU data to the either one of the communication lines L1 and L2.

Upon determining that the server data is to be transmitted as device data, the out-of-vehicle relay device 30 transmits the device data to at least one of the electrical devices 23a and 23b via the switch 35. As previously described, the communication device 24 outputs server data received from the server 11 to the out-of-vehicle relay device 30, and therefore the out-of-vehicle relay device 30 relays data that is from the server 11 and bound for the electrical devices 23a and 23b.

Upon determining that the server data is to be transmitted as ECU data, the out-of-vehicle relay device 30 outputs the ECU data to the in-vehicle relay device 31 via the switch 34. As will be described later, ECU data that is output from the out-of-vehicle relay device 30 to the in-vehicle relay device 31 is transmitted by the in-vehicle relay device 31 to at least one of the ECUs 21a, 21b, 22a, and 22b. The out-of-vehicle relay device 30 relays data that is from the server 11 and bound for the ECUs 21a, 21b, 22a, and 22b by passing the ECU data to the in-vehicle relay device 31. The server 11 corresponds to an external apparatus.

The out-of-vehicle relay device 30 receives vehicle data from the in-vehicle relay device 31. Multiple pieces of vehicle data received from the in-vehicle relay device 31 are stored in the out-of-vehicle relay device 30. If vehicle transmission request data received from the communication device 24 is successfully authenticated, the out-of-vehicle relay device 30 selects vehicle data that is indicated by the information included in the vehicle transmission request data from among the stored pieces of vehicle data, and outputs the selected vehicle data to the communication device 24 via the switch 33. As previously described, the communication device 24 transmits the vehicle data received from the out-of-vehicle relay device 30 to the server 11. As will be described later, the in-vehicle relay device 31 outputs ECU data received from the ECUs 21a, 21b, 22a, and 22b to the out-of-vehicle relay device 30 as vehicle data. By receiving vehicle data from the in-vehicle relay device 31, the out-of-vehicle relay device 30 relays data that is from one of the ECUs 21a, 21b, 22a, and 22b and bound for the server 11.

The out-of-vehicle relay device 30 receives server transmission request data from the electrical devices 23a and 23b via the switch 35. Upon receiving the server transmission request data, the out-of-vehicle relay device 30 outputs the server transmission request data to the communication device 24 via the switch 33. As previously described, the communication device 24 transmits the server transmission request data received from the out-of-vehicle relay device 30 to the server 11. The out-of-vehicle relay device 30 relays data that is from the electrical devices 23a and 23b and bound for the server 11.

The in-vehicle relay device 31 receives ECU data from the out-of-vehicle relay device 30 via the switch 34. The in-vehicle relay device 31 transmits the received ECU data to at least one of the ECUs 21a, 21b, 22a, and 22b. The in-vehicle relay device 31 also outputs ECU data received from one of the ECUs 21a, 21b, 22a, and 22b to the out-of-vehicle relay device 30 as vehicle data via the switch 34.

The in-vehicle relay device 31 transmits ECU data received from either one of the ECUs 21a and 21b to the ECUs 22a and 22b, and transmits ECU data received from either one of the ECUs 22a and 22b to the ECUs 21a and 21b. In this way, by communicating with the ECUs 21a, 21b, 22a, and 22b installed in the vehicle 12, the in-vehicle relay device 31 relays data between the ECUs 21a, 21b, 22a, and 22b.

The out-of-vehicle relay device 30 and the in-vehicle relay device 31 respectively function as an external relay device and an internal relay device. The ECUs 21a, 21b, 22a, and 22b function as communication apparatuses. The electrical devices 23a and 23b function as second communication apparatuses.

When the switch 33 is on, data input/output can be performed between the communication device 24 and the out-of-vehicle relay device 30, and when the switch 33 is off, data input/output between the communication device 24 and the out-of-vehicle relay device 30 is prohibited.

When the switch 34 is on, data input/output can be performed between the out-of-vehicle relay device 30 and the in-vehicle relay device 31, and when the switch 34 is off, data input/output between the out-of-vehicle relay device 30 and the in-vehicle relay device 31 is prohibited.

When the switch 35 is on, the electrical devices 23a and 23b and the out-of-vehicle relay device 30 can perform communication via the communication line L3, and when the switch 35 is off, communication via the communication line L3 is prohibited.

The switches 32, 33, 34, and 35 are normally maintained in the on state. The switches 32, 33, 34, and 35 are switched from on to off if the relaying performed by the out-of-vehicle relay device 30 is suspended.

The out-of-vehicle relay device 30 outputs, to the in-vehicle relay device 31 via the switch 34, associated data that is associated with data input to the communication device 24 or data output from the communication device 24. The in-vehicle relay device 31 switches the switches 32, 33, 34, and 35 from on to off based on the associated data received from the out-of-vehicle relay device 30.

Next, the detailed configuration of the out-of-vehicle relay device 30 will be described. The out-of-vehicle relay device 30 has input/output units 40 and 41, a communication unit 42, a timer unit 43, a storage unit 44, and a control unit 45. These units are connected to a bus 46. The input/output unit 40 is connected to one end of the switch 33, in addition to the bus 46. The input/output unit 41 is connected to one end of the switch 34, in addition to the bus 46. The communication unit 42 is connected to the communication line L3.

The input/output units 40 and 41, the communication unit 42, the timer unit 43, the storage unit 44, and the control unit 45 each operate when power is supplied from the battery 25 to the out-of-vehicle relay device 30 via the switch 32, and stop operating when the switch 32 is switched off and the supply of power from the battery 25 to the out-of-vehicle relay device 30 is stopped.

Server data and vehicle transmission request data received by the communication device 24 from the server 11 is input from the communication device 24 to the input/output unit 40 via the switch 33. Upon receiving the server data or the vehicle transmission request data from the communication device 24, the input/output unit 40 notifies that fact to the control unit 45. The input/output unit 40 also outputs vehicle data or server transmission request data via the switch 33 in accordance with an instruction from the control unit 45. The data output by the input/output unit 40 is transmitted to the server 11 by the communication device 24. The input/output unit 40 functions as an input unit and an output unit.

The input/output unit 41 outputs ECU data or associated data to the in-vehicle relay device 31 via the switch 34 in accordance with an instruction from the control unit 45. The input/output unit 41 receives vehicle data from the in-vehicle relay device 31 via the switch 34. Upon receiving the vehicle data, the input/output unit 41 notifies that fact to the control unit 45.

The communication unit 42 transmits device data to the electrical devices 23a and 23b via the switch 35 in accordance with an instruction from the control unit 45. The communication unit 42 also receives server transmission request data from the electrical devices 23a and 23b via the switch 35. Upon receiving the server transmission request data, the communication unit 42 notifies that fact to the control unit 45.

The control unit 45 acquires date/time data that indicates the date and time from the timer unit 43. The date/time data indicates the date and time at the time of acquisition by the control unit 45. The date and time include the year, month, day, and time.

The storage unit 44 stores a control program P1 and an encryption key. The storage unit 44 is also provided with a storage region for relaying performed by the out-of-vehicle relay device 30.

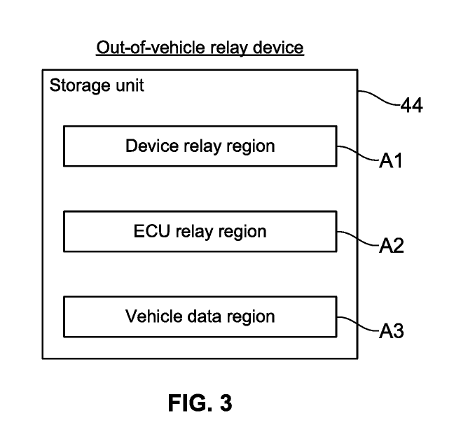

FIG. 3 is an illustrative diagram of storage regions of the storage unit 44 in the out-of-vehicle relay device 30. The storage unit 44 is provided with a device relay region A1, an ECU relay region A2, and a vehicle data region A3, as storage regions.

Device data that is to be transmitted to the electrical devices 23a and 23b is stored in the device relay region A1. ECU data that is to be output to the in-vehicle relay device 31 is stored in the ECU relay region A2. Vehicle data received from the in-vehicle relay device 31 is stored in the vehicle data region A3.

The control unit 45 has a CPU (Central Processing Unit) that is not shown. By executing the control program P1 stored in the storage unit 44, the CPU of the control unit 45 executes server data storage processing, device data transmission processing, ECU data output processing, vehicle data storage processing, vehicle data output processing, and server transmission request data output processing.

In the server data storage processing, server data that was input to the input/output unit 40 is stored as device data or ECU data in the device relay region A1 or the ECU relay region A2. In the device data transmission processing, device data is transmitted to at least one of the electrical devices 23a and 23b. In the ECU data output processing, ECU data is output to the in-vehicle relay device 31. Accordingly, the out-of-vehicle relay device 30 passes ECU data to the in-vehicle relay device 31. In the vehicle data storage processing, vehicle data received from the in-vehicle relay device 31 is stored. In the vehicle data output processing, vehicle data is output to the communication device 24. In the server transmission request data output processing, server transmission request data is output to the communication device 24.

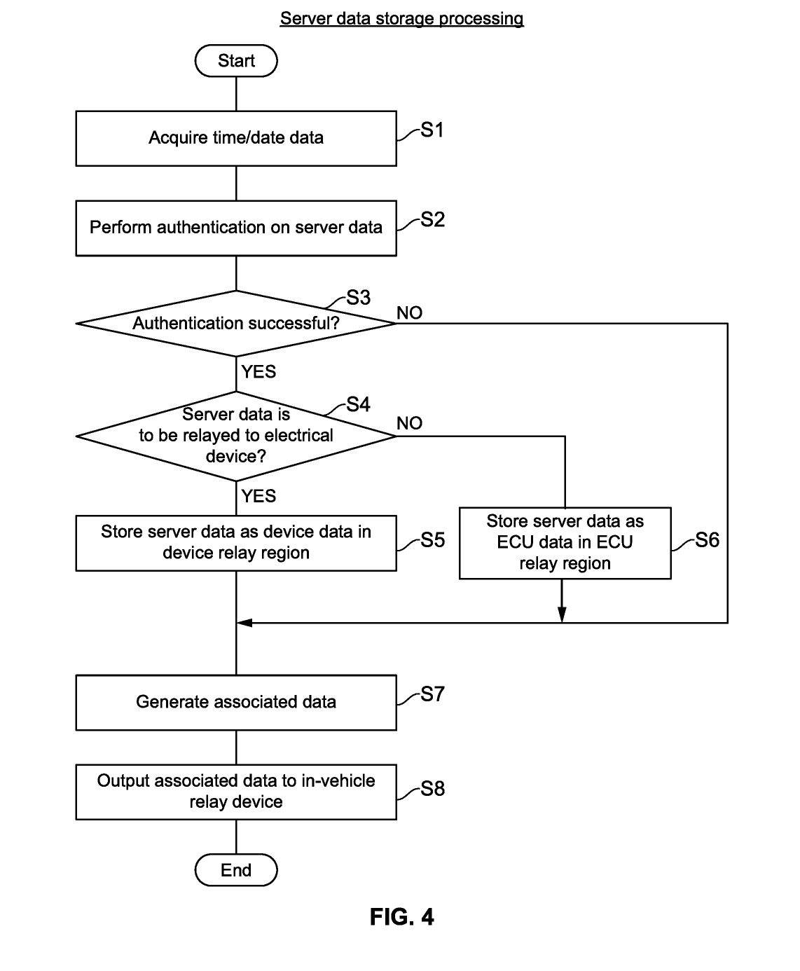

FIG. 4 is a flowchart showing a procedure of server data storage processing executed by the control unit 45 of the out-of-vehicle relay device 30. The control unit 45 executes the server data storage processing if server data and an authentication code are input from the communication device 24 to the input/output unit 40. First, the control unit 45 acquires date/time data from the timer unit 43 (step S1).

Next, with use of the encryption key stored in the storage unit 44, the control unit 45 performs authentication on the server data that was input from the communication device 24 to the input/output unit 40 (step S2). Specifically, as previously described, the control unit 45 generates an authentication code with use of the encryption key and the server data that was input to the input/output unit 40. The control unit 45 then determines whether the generated authentication code matches the authentication code that was input to the input/output unit 40 along with the server data. Authentication is performed on the server data by making this determination. The control unit 45 also functions as an authentication unit.

Next, the control unit 45 determines whether or not the server data input to the input/output unit 40 was successfully authenticated (step S3). If the authentication code that was generated using the server data and the encryption key matches the authentication code that was input to the input/output unit 40 along with the server data, the control unit 45 determines that the authentication was successful. Also, if the authentication code that was generated using the server data and the encryption key does not match the authentication code that was input to the input/output unit 40 along with the server data, the control unit 45 determines that the authentication failed.

Upon determining that the authentication was successful (S3: YES), the control unit 45 determines that the server data is to be relayed to at least one of the electrical devices 26a and 26b (step S4). For example, if transmission destination information indicating the transmission destination is included in the server data, the control unit 45 determines whether or not the server data is to be transmitted to at least one of the electrical devices 26a and 26b, based on the transmission destination indicated by the transmission destination information.

Upon determining that the server data is to be transmitted to at least one of the electrical devices 26a and 26b (S4: YES), the control unit 45 stores the server data as device data in the device relay region A1 of the storage unit 44 (step S5). Upon determining that the server data is not to be transmitted to either of the electrical devices 26a and 26b, that is to say, is to be transmitted to at least one of the ECUs 21a, 21b, 22a, and 22b (S4: NO), the control unit 45 stores the server data as ECU data in the ECU relay region A2 of the storage unit 44 (step S6).

Upon determining that the authentication failed (S3: NO), or after either one of steps S5 and S6 has been executed, the control unit 45 generates associated data that is associated with the server data that was input from the communication device 24 to the input/output unit 40 (step S7). The associated data that is generated in step S7 includes information indicating the date/time at which the server data was input from the communication device 24 to the input/output unit 40, the fact that the operation performed by the communication device 24 was a reception operation, authentication success/failure, the content of the data input to the input/output unit 40, and the amount of data that was input to the input/output unit 40. Here, the date/time is the date/time indicated by the date/time data that was acquired in step S1.

Next, the control unit 45 instructs the input/output unit 41 to output the associated data generated in step S7 to the in-vehicle relay device 31 (step S8). Thereafter, the control unit 45 ends the server data storage processing. The input/output unit 41 functions as a second output unit.

The control unit 45 periodically executes the device data transmission processing. In the device data transmission processing, the control unit 45 determines whether or not device data is stored in the device relay region A1 of the storage unit 44. Upon determining that device data is not stored in the device relay region A1, the control unit 45 ends the device data transmission processing. Upon determining that device data is stored in the device relay region A1, the control unit 45 instructs the communication unit 42 to transmit the device data stored in the device relay region A1 to at least one of the electrical devices 23a and 23b. If transmission destination information is included in the device data, the communication device 24 transmits the device data to the one of the electrical devices 23a and 23b that is the transmission destination indicated in the transmission destination information. Thereafter, the control unit 45 deletes the device data transmitted by the communication unit 42 from the device relay region A1, and ends the device data transmission processing.

The control unit 45 periodically executes the ECU data output processing. In the ECU data output processing, the control unit 45 determines whether or not ECU data is stored in the ECU relay region A2 of the storage unit 44. Upon determining that ECU data is not stored in the ECU relay region A2, the control unit 45 ends the ECU data output processing. Upon determining that ECU data is stored in the ECU relay region A2, the control unit 45 instructs the input/output unit 41 to output the ECU data stored in the ECU relay region A2 to the in-vehicle relay device 31. Thereafter, the control unit 45 deletes the ECU data that was output by the input/output unit 40 from the ECU relay region A2, and ends the ECU data output processing.

The control unit 45 executes the vehicle data storage processing if vehicle data is input from the in-vehicle relay device 31 to the input/output unit 41. In the vehicle data storage processing, the control unit 45 stores the vehicle data that was input from the in-vehicle relay device 31 to the input/output unit 41 in the vehicle data region A3 of the storage unit 44, and then ends the vehicle data storage processing.

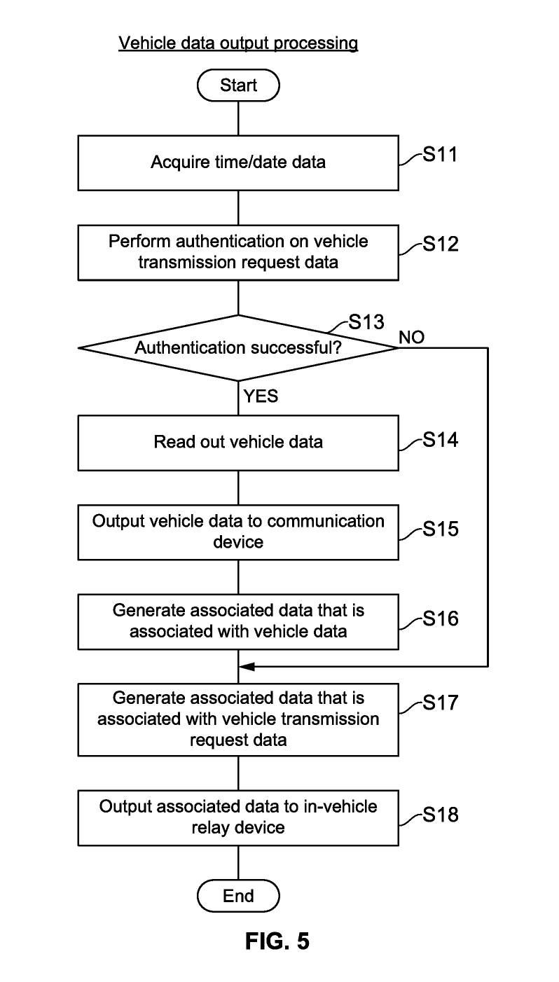

FIG. 5 is a flowchart showing a procedure of vehicle data output processing executed by the control unit 45 of the out-of-vehicle relay device 30. The control unit 45 executes the vehicle data output processing if vehicle transmission request data is input to the input/output unit 40 along with an authentication code. First, the control unit 45 acquires date/time data from the timer unit 43 (step S11).

Next, with use of the encryption key stored in the storage unit 44, the control unit 45 performs authentication on the vehicle transmission request data that was input to the input/output unit 40 (step S12). Specifically, as previously described, the control unit 45 generates an authentication code with use of the encryption key and the vehicle transmission request data that was input to the input/output unit 40. The control unit 45 then determines whether the generated authentication code matches the authentication code that was input to the input/output unit 40 along with the vehicle transmission request data. Authentication is performed on the vehicle transmission request data by making this determination.

Next, the control unit 45 determines whether or not the vehicle transmission request data input to the input/output unit 40 was successfully authenticated (step S13). If the authentication code that was generated using the vehicle transmission request data and the encryption key matches the authentication code that was input to the input/output unit 40 along with the vehicle transmission request data, the control unit 45 determines that the authentication was successful. Also, if the authentication code that was generated using the vehicle transmission request data and the encryption key does not match the authentication code that was input to the input/output unit 40 along with the vehicle transmission request data, the control unit 45 determines that the authentication failed.

Upon determining that the authentication was successful (S13: YES), the control unit 45 reads out, from the vehicle data region A3 of the storage unit 44, vehicle data that is indicated by the information included in the vehicle transmission request data that was input from the input/output unit 40 (step S14). Next, the control unit 45 instructs the input/output unit 40 to output the vehicle data that was read out in step S14 to the communication device 24 (step S15), and generates associated data that is associated with the vehicle data that was output to the communication device 24 by the input/output unit 40 (step S16). The associated data generated in step S16 includes information indicating the date/time that the vehicle data was output from the input/output unit 40 to the communication device 24, the fact that the operation performed by the communication device 24 was a transmission operation, the content of the data output from the input/output unit 40, and the amount of data that was output from the input/output unit 40. Here, the date/time is the date/time indicated by the date/time data that was acquired in step S11.

Upon determining that the authentication failed (S13: NO), or after step S16 has been executed, the control unit 45 generates associated data that is associated with the vehicle transmission request data that was input from the communication device 24 to the input/output unit 40 (step S17). The associated data that is generated in step S17 includes information indicating the date/time at which the vehicle transmission request data was input from the communication device 24 to the input/output unit 40, authentication success/failure, the fact that the operation performed by the communication device 24 was a reception operation, the content of the data input to the input/output unit 40, and the amount of data that was input to the input/output unit 40. Here, the date/time is the date/time indicated by the date/time data that was acquired in step S11.

After step S17 has been executed, the control unit 45 instructs the input/output unit 41 to output the associated data to the in-vehicle relay device 31 (step S18). Upon determining that authentication was successful in step S13, in step S18, the control unit 45 outputs the associated data that was generated in steps S16 and S17 to the in-vehicle relay device 31. Also, upon determining that authentication failed in step S13, in step S18, the control unit 45 outputs the associated data that was generated in step S17 to the in-vehicle relay device 31.

After step S18 has been executed, the control unit 45 ends the vehicle data output processing.

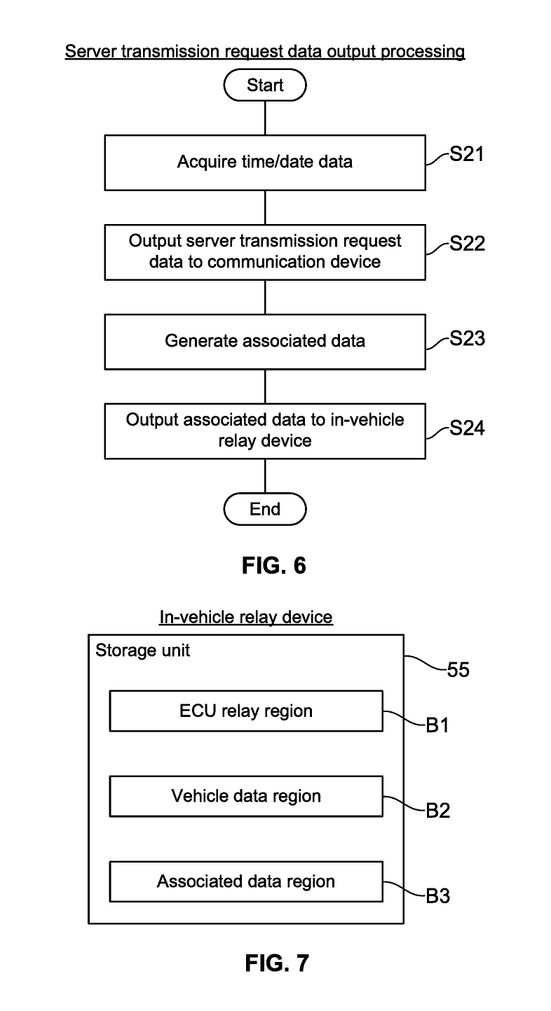

FIG. 6 is a flowchart showing a procedure of server transmission request data output processing executed by the control unit 45 of the out-of-vehicle relay device 30. The control unit 45 executes the server transmission request data output processing if the communication unit 42 receives server transmission request data from either one of the electrical devices 23a and 23b. First, the control unit 45 acquires date/time data from the timer unit 43 (step S21).

Next, the control unit 45 instructs the input/output unit 40 to output the server transmission request data received by the communication unit 42 to the communication device 24 (step S22), and generates associated data that is associated with the server transmission request data that was output by the input/output unit 40 (step S23). The associated data generated in step S23 includes information indicating the date/time that the vehicle data was output by the input/output unit 40, the fact that the operation performed by the communication device 24 was a transmission operation, the content of the data output from the input/output unit 40, and the amount of data that was output from the input/output unit 40. Here, the date/time is the date/time indicated by the date/time data that was acquired in step S21.

Next, the control unit 45 instructs the input/output unit 41 to output the associated data generated in step S23 to the in-vehicle relay device 31 (step S24), and then ends the server transmission request data output processing.

Next, the detailed configuration of the in-vehicle relay device 31 will be described. As shown in FIG. 2, the in-vehicle relay device 31 has an input/output unit 50, communication units 51 and 52, a switching unit 53, an announcement unit 54, a storage unit 55, and a control unit 56. These units are connected to a bus 57. The input/output unit 50 is connected to the other end of the switch 34, in addition to the bus 57. The communication units 51 and 52 are respectively connected to the communication lines L1 and L2 in addition to the bus 57.

The input/output unit 50, the communication units 51 and 52, the switching unit 53, the announcement unit 54, the storage unit 55, and the control unit 56 operate with use of power supplied from the battery 25 to the in-vehicle relay device 31.

The input/output unit 50 receives ECU data and associated data from the input/output unit 41 of the out-of-vehicle relay device 30 via the switch 34. Upon receiving ECU data or associated data from the input/output unit 41 of the out-of-vehicle relay device 30, the input/output unit 50 notifies that fact to the control unit 56. The input/output unit 50 also outputs vehicle data via the switch 34 in accordance with an instruction from the control unit 56.

The communication unit 51 receives ECU data from the ECUs 21a and 21b via the communication line L1. Upon receiving the ECU data, the communication unit 51 notifies that fact to the control unit 56. The communication unit 51 transmits the ECU data to the ECUs 21a and 21b in accordance with an instruction from the control unit 56.

Similarly, the communication unit 52 receives ECU data from the ECUs 22a and 22b via the communication line L2. Upon receiving the ECU data, the communication unit 52 notifies that fact to the control unit 56. The communication unit 52 transmits the ECU data to the ECUs 22a and 22b in accordance with an instruction from the control unit 56.

The switching unit 53 switches the on and off states of the switches 32, 33, 34, and 35 in accordance with an instruction from the control unit 56.

The announcement unit 54 makes an announcement in accordance with an instruction from the control unit 56. The announcement unit 54 makes an announcement by, for example, lighting a lamp (not shown) or displaying a message on a display unit (not shown).

The storage unit 55 stores a control program P2. The storage unit 44 is also provided with a storage region for storing associated data, and a storage region for relaying performed by the in-vehicle relay device 31.

FIG. 7 is an illustrative diagram of the storage regions of the storage unit 55 in the in-vehicle relay device 31. The storage unit 55 is provided with an ECU relay region B1, a vehicle data region B2, and an associated data region B3, as storage regions.

ECU data that is to be transmitted to at least one of the ECUs 21a, 21b, 22a, and 22b is stored in the ECU relay region B1. Vehicle data that is to be output to the input/output unit 41 of the out-of-vehicle relay device 30 is stored in the vehicle data region B2. Associated data that was input to the input/output unit 50 is stored in the associated data region B3.

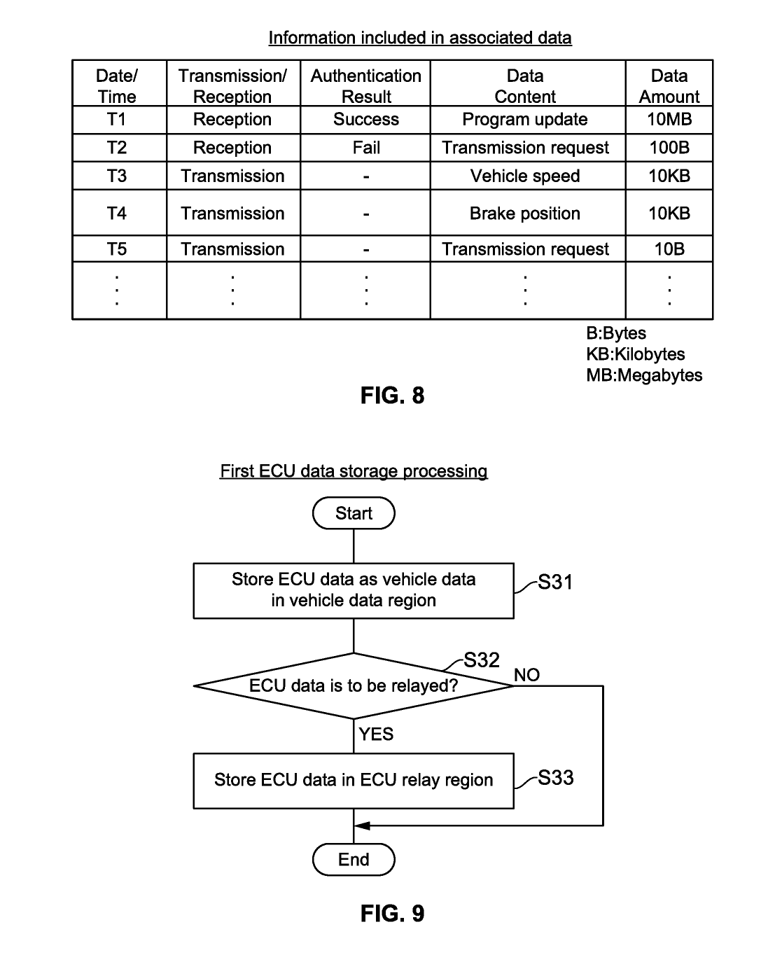

FIG. 8 is a table showing an example of information indicated by the associated data stored in the associated data region B3. Information included in each of five pieces associated data is shown in FIG. 8. T1, T2, . . . , T5 each show a date/time.

The associated data includes information indicating whether the operation performed by the communication device 24 was a reception or transmission operation. If the operation performed by the communication device 24 is a reception operation, the associated data includes information indicating the date/time when the data was input to the input/output unit 40 of the out-of-vehicle relay device 30, success/failure of the authentication performed on the data input to the input/output unit 40, the content of the data input to the input/output unit 40, and the amount of data that was input to the input/output unit 40.

If the operation performed by the communication device 24 is a transmission operation, the associated data includes information indicating the date/time that the data was output from the input/output unit 40 of the out-of-vehicle relay device 30 to the server 11, the content of the data output from the input/output unit 40, and the amount of data that was output from the input/output unit 40. If the operation performed by the communication device 24 is a transmission operation, authentication is not performed, and therefore the associated data does not include information indicating authentication success/failure. Also, examples of the data content indicated by the information of the associated data include program updating, transmission request, vehicle speed, and brake pedal position.

In the case of the information of the associated data, the date/time and the transmission/reception operation performed by the communication device 24 are related to the input of data to the input/output unit 40, or the output of data from the input/output unit 40. Authentication success/failure is related to the failure or success of authentication performed by the control unit 56 of the out-of-vehicle relay device 30. The data amount is related to the amount of data that was input from the communication device 24 to the input/output unit 40 of the out-of-vehicle relay device 30, or the amount of data that was output from the input/output unit 40 of the out-of-vehicle relay device 30 to the communication device 24.

As previously described, the on and off states of the switches 32, 33, 34, and 35 are switched based on the associated data.

The control unit 56 of the in-vehicle relay device 31 shown in FIG. 2 also has a CPU (not shown). By executing the control program P2 stored in the storage unit 55, the CPU of the control unit 56 performs first ECU data storage processing, second ECU data storage processing, ECU data transmission processing, vehicle data output processing, associated data storage processing, and relay suspend processing.

In the first ECU data storage processing, ECU data received by the communication units 51 and 52 is stored. In the second ECU data storage processing, ECU data input from the input/output unit 41 of the out-of-vehicle relay device 30 to the input/output unit 50 of the in-vehicle relay device 31 is stored. In the ECU data transmission processing, ECU data is transmitted to at least one of the ECUs 21a, 21b, 22a, and 22b. In the vehicle data output processing, ECU data received from the ECUs 21a, 21b, 22a, and 22b is output as vehicle data to the input/output unit 41 of the out-of-vehicle relay device 30. Accordingly, the out-of-vehicle relay device 30 receives data from the in-vehicle relay device 31. In the associated data storage processing, associated data that was input from the input/output unit 41 of the out-of-vehicle relay device 30 to the input/output unit 50 of the in-vehicle relay device 31 is stored. In the relay suspend processing, relaying performed by the out-of-vehicle relay device 30 is suspended based on associated data.

FIG. 9 is a flowchart showing a procedure of first ECU data storage processing executed by the control unit 56 of the in-vehicle relay device 31. The control unit 56 executes the first ECU data storage processing if the communication unit 51 receives ECU data via the communication line L1, or the communication unit 52 receives ECU data via the communication line L2.

First, the control unit 56 stores ECU data received by either one of the communication units 51 and 52 in the vehicle data region B2 of the storage unit 55 as vehicle data (step S31), and then determines whether the ECU data received by the one of the communication units 51 and 52 is to be relayed via either one of the communication lines L1 and L2 (step S32). The storage unit 55 stores a correspondence table in which identification information is associated with information indicating the communication unit that is to transmit ECU data. In step S32, if the identification information included in the ECU data is indicated in the correspondence table, the control unit 56 determines that the ECU data is to be relayed, and if the identification information included in the ECU data is not indicated in the correspondence table, the control unit 56 determines that the ECU data is not to be relayed.

Upon determining that the ECU data is to be relayed (S32: YES), the control unit 56 stores the ECU data received from the one of the communication units 51 and 52 in the ECU relay region B1 (step S33).

Note that in steps S31, S32, and S33, if the first ECU data storage processing was executed due to the reception of ECU data by the communication unit 51, the communication unit 51 corresponds to the one of the communication unit 51 and 52. Also, if the first ECU data storage processing was executed due to the reception of ECU data by the communication unit 52, the communication unit 52 corresponds to the one of the communication units 51 and 52.

Upon determining that the ECU data is not to be relayed (S32: NO), or after step S33 has been executed, the control unit 56 ends the first ECU data storage processing.

The control unit 56 executes the second ECU data storage processing if ECU data is input from the input/output unit 41 of the out-of-vehicle relay device 30 to the input/output unit 50 of the in-vehicle relay device 31. In the second ECU data storage processing, the control unit 56 adds identification information indicating the transmission source, that is to say the server 11, to the ECU data that was input to the input/output unit 50, and stores the ECU data including this identification information in the ECU relay region B1 of the storage unit 55. Thereafter, the second ECU data storage processing is ended.

The control unit 56 periodically executes the ECU data transmission processing. In the ECU data transmission processing, the control unit 56 determines whether or not ECU data is stored in the ECU relay region B1 of the storage unit 55. Upon determining that ECU data is not stored in the ECU relay region B1, the control unit 56 ends the ECU data transmission processing. Upon determining that ECU data is stored in the ECU relay region B1, the control unit 56 selects, out of the communication units 51 and 52, the communication unit that is to transmit the ECU data, based on the identification information included in the ECU data and the previously-described correspondence table. Next, the control unit 56 instructs the selected communication unit to transmit the ECU data, and then deletes the transmitted ECU data from the ECU relay region B1. Thereafter, the control unit 56 ends the ECU data transmission processing.

In the case where the identification information included in the ECU data indicates the server 11, if information indicating both the communication units 51 and 52 is associated with the identification information indicating the server 11 in the correspondence table for example, the ECU data that includes the identification information indicating the server 11 is transmitted to all of the ECUs 21a, 21b, 22a, and 22b. For example, in the case where ECU data that includes identification information indicating the server 11 further includes transmission destination information that indicates a transmission destination, when the ECUs 21a, 21b, 22a, and 22b receive the ECU data that includes the identification information indicating the server 11, the ECUs determine whether or not the received ECU data is to be accepted based on the transmission destination indicated by the transmission destination information included in the ECU data. In this case, for each of the ECUs 21a, 21b, 22a, and 22b, the ECU accepts the received ECU data if it is the transmission destination indicated by the transmission destination information, and discards the received ECU data if it is not the transmission destination indicated by the transmission destination information.

The control unit 56 executes the vehicle data output processing if ECU data is received by either one of the communication units 51 and 52. In the vehicle data output processing, the control unit 56 instructs the input/output unit 50 to output the ECU data received by one of the communication units 51 and 52 to the input/output unit 41 of the out-of-vehicle relay device 30 as vehicle data. Thereafter, the control unit 56 ends the vehicle data output processing.

The control unit 56 executes the associated data storage processing if associated data is input from the input/output unit 41 of the out-of-vehicle relay device 30 to the input/output unit 50. In the associated data storage processing, the control unit 56 stores the associated data that was input to the input/output unit 50 in the associated data region B3 of the storage unit 55. Thereafter, the control unit 56 ends the associated data storage processing.

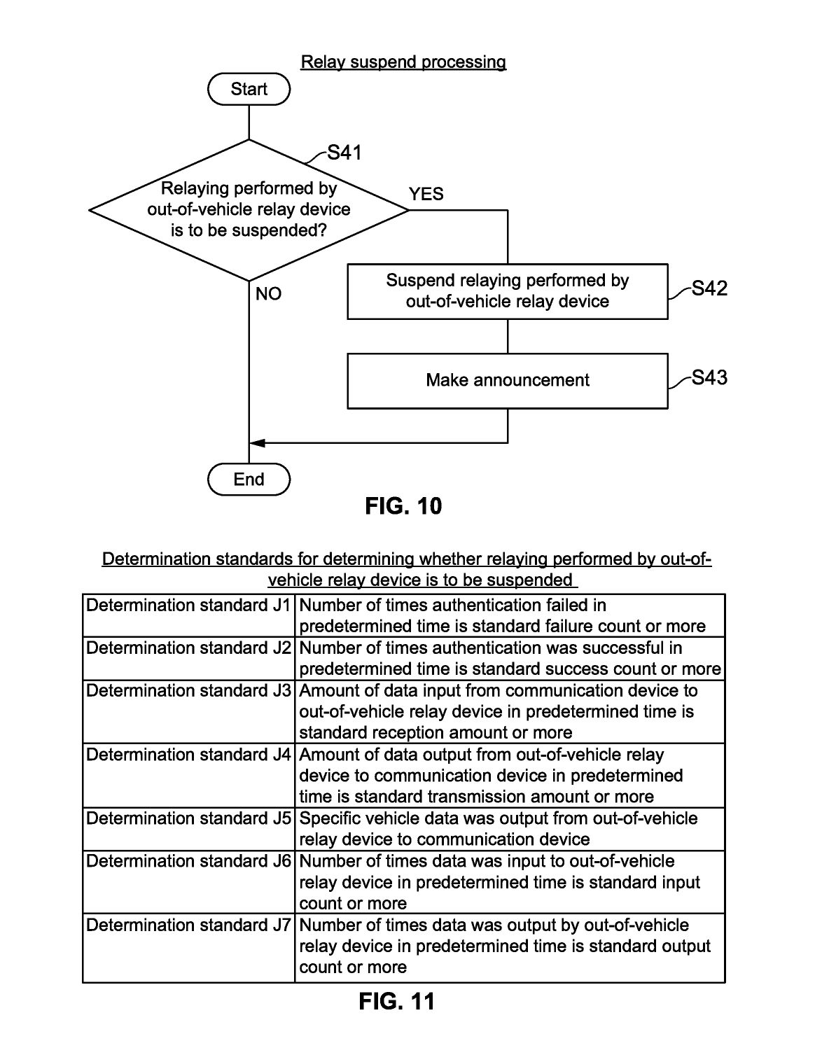

FIG. 10 is a flowchart showing a procedure of relay suspend processing that is executed by the control unit 56 of the in-vehicle relay device 31. When the switches 32, 33, 34, and 35 are on, the control unit 56 periodically executes the relay suspend processing. First, the control unit 56 determines whether or not relaying performed by the out-of-vehicle relay device 30 is to be suspended based on one or more pieces of associated data stored in the associated data region B3 of the storage unit 55 (step S41). The control unit 56 also functions as a determination unit.

The storage unit 55 stores determination standards for determining whether or not relaying performed by the out-of-vehicle relay device 30 is to be suspended. In step S41, the control unit 56 determines whether or not relaying performed by the out-of-vehicle relay device 30 is to be suspended based on the determination standards and one or more pieces of associated data stored in the storage unit 55.

FIG. 11 is a table showing determination standards for determining whether or not relaying performed by the out-of-vehicle relay device 30 is to be suspended. In FIG. 11, determination standards J1, J2, . . . , and J7 are stored in the storage unit 55. In step S41, the control unit 56 determines that relaying performed by the out-of-vehicle relay device 30 is to be suspended if at least one of the determination standards J1, J2, . . . , and J7 is satisfied, and determines that relaying performed by the out-of-vehicle relay device 30 is not to be suspended if none of the determination standards J1, J2, . . . , and J7 are satisfied.

The determination standard J1 is that the number of times that the authentication of server data input from the communication device 24 to the out-of-vehicle relay device 30 failed in a predetermined time is greater than or equal to a standard failure count. If the number of authentication failures is large in the predetermined time, this indicates the possibility that, for example, data and authentication codes generated from the data with use of various encryption keys are being repeatedly transmitted to the communication device 24 in order to search for an encryption key that will be successfully authenticated. In this case, suspending the relaying performed by the out-of-vehicle relay device 30 preemptively prevents unsuitable data from being relayed to at least one of the ECUs 21a, 21b, 22a, and 22b and electrical devices 23a and 23b.

The number of times that authentication failed in the predetermined time is calculated based on information indicated by one or more pieces of associated data stored in the associated data region B3. The standard failure count is constant, and is stored in the storage unit 55 in advance.

The determination standard J2 is that the number of times that the authentication of server data input from the communication device 24 to the out-of-vehicle relay device 30 was successful in a predetermined time is greater than or equal to a standard success count. Normally, the authentication performed by the control unit 56 of the out-of-vehicle relay device 30 fails a certain percentage of the time. For this reason, a large number of authentication successes in the predetermined time is unnatural and indicates a possibility that the control program P1 has been manipulated such that it is determined that authentication is successful for data input from the communication device 24 to the input/output unit 40 of the out-of-vehicle relay device 30. In this case, by suspending the relaying performed by the out-of-vehicle relay device 30, it is possible to suppress the occurrence of a problem caused by a manipulated program.

The number of times that authentication was successful in the predetermined time is calculated based on information indicated by one or more pieces of associated data stored in the associated data region B3. The standard success count is constant, and is stored in the storage unit 55 in advance.

The determination standard J3 is that the amount of data input from the communication device 24 to the input/output unit 40 of the out-of-vehicle relay device 30 in a predetermined time is greater than or equal to a standard reception amount. If a large amount of data is input from the communication device 24 to the input/output unit 40 of the out-of-vehicle relay device 30 in the predetermined time, there is a possibility that unsuitable data is being successively transmitted to the communication device 24 at short time intervals. In this case, by suspending the relaying performed by the out-of-vehicle relay device 30, it is possible to stop the input of unsuitable data.

The amount of data that is input to the input/output unit 40 of the out-of-vehicle relay device 30 in the predetermined time is calculated based on information indicated by one or more pieces of associated data stored in the associated data region B3. The standard reception amount is constant, and is stored in the storage unit 55 in advance.

The determination standard J4 is that the amount of data that is output from the input/output unit 40 of the out-of-vehicle relay device 30 to the communication device 24 in a predetermined time is greater than or equal to a standard transmission amount. If a large amount of data is output from the input/output unit 40 of the out-of-vehicle relay device 30 to the communication device 24 in the predetermined time, there is a possibility that the control program P1 has been manipulated, and the content of the vehicle data output processing, the server transmission request data output processing, or the like has been changed. In this case, by suspending the relaying performed by the out-of-vehicle relay device 30, it is possible to suppress the leakage of vehicle data from the vehicle 12.

The amount of data that is output from the input/output unit 40 of the out-of-vehicle relay device 30 in the predetermined time is calculated based on information indicated by one or more pieces of associated data stored in the associated data region B3. The standard transmission amount is constant, and is stored in the storage unit 55 in advance.

The determination standard J5 is that a specific piece of vehicle data was output from the input/output unit 40 of the out-of-vehicle relay device 30 to the communication device 24. The specific piece of vehicle data is, for example, vehicle data that should not be output from the input/output unit 40 of the out-of-vehicle relay device 30 to the communication device 24. Accordingly, if the specific piece of vehicle data was output to the communication device 24, this indicates the possibility that the control program P1 was manipulated, and the content of the vehicle data output processing has been changed for example. In this case, by suspending the relaying performed by the out-of-vehicle relay device 30, it is possible to suppress the leakage of the specific piece of vehicle data.

Content data that includes information indicating the content of the specific piece of vehicle data is stored in the storage unit 55 in advance, for example. In this case, whether or not the specific piece of vehicle data was output from the input/output unit 40 of the out-of-vehicle relay device 30 is determined based on information included in the associated data and the content data.

The determination standard J6 is that the number of times that data is input from the communication device 24 to the out-of-vehicle relay device 30 in a predetermined time is greater than or equal to a standard input count. If data is input from the communication device 24 to the input/output unit 40 of the out-of-vehicle relay device 30 a large number of times in the predetermined time, there is a possibility that unsuitable data is being successively transmitted to the communication device 24 at short time intervals. In this case, by suspending the relaying performed by the out-of-vehicle relay device 30, it is possible to stop the input of unsuitable data.

The amount of data that is input to the input/output unit 40 of the out-of-vehicle relay device 30 in the predetermined time is calculated based on information indicated by one or more pieces of associated data stored in the associated data region B3. The standard input count is constant, and is stored in the storage unit 55 in advance.

The determination standard J7 is that the number of times that data is output from the input/output unit 40 of the out-of-vehicle relay device 30 to the communication device 24 in a predetermined time is greater than or equal to a standard output count. If data is output from the input/output unit 40 of the out-of-vehicle relay device 30 to the communication device 24 a large number of times in the predetermined time, there is a possibility that the control program P1 has been manipulated, and the content of the vehicle data output processing, the server transmission request data output processing, or the like has been changed. In this case, by suspending the relaying performed by the out-of-vehicle relay device 30, it is possible to suppress the leakage of vehicle data from the vehicle 12.

The number of times that data is output from the input/output unit 40 of the out-of-vehicle relay device 30 in the predetermined time is calculated based on information indicated by one or more pieces of associated data stored in the associated data region B3. The standard output count is constant, and is stored in the storage unit 55 in advance.

The predetermined times related to the determination standards J1, J2, . . . , and J7 are constant, and are set individually.

In the relay suspend processing, upon determining that relaying performed by the out-of-vehicle relay device 30 is to be suspended (S41: YES), the control unit 56 suspends the relaying performed by the out-of-vehicle relay device 30 by causing the switching unit 53 to switch the switches 32, 33, 34, and 35 from on to off (step S42).

When the switching unit 53 switches the switch 32 to the off state, the supply of power from the battery 25 to the out-of-vehicle relay device 30 is stopped. Accordingly, the relaying performed by the out-of-vehicle relay device 30 is reliably suspended. The switching unit 53 functions as a power supply stopping unit.

When the switching unit 53 switches the switch 33 to the off state, the input and output of data between the communication device 24 and the input/output unit 40 of the out-of-vehicle relay device 30, that is to say the input of data from the server 11 to the input/output unit 40 via the communication device 24 and the output of data from the input/output unit 40 to the server 11 via the communication device 24, is prohibited. Accordingly, the relaying performed by the out-of-vehicle relay device 30 is suspended even more reliably. The switching unit 53 also functions as a prohibiting unit.

When the switching unit 53 switches the switch 34 to the off state, the input and output of data between the input/output unit 41 of the out-of-vehicle relay device 30 and the input/output unit 50 of the in-vehicle relay device 31 is stopped. Accordingly, the relaying of data between the server 11 and one of the ECUs 21a, 21b, 22a, and 22b is suspended.

When the switching unit 53 switches the switch 35 to the off state, the transmission and reception of data between the communication unit 42 of the out-of-vehicle relay device 30 and either one of the electrical devices 23a and 23b is stopped. Accordingly, the relaying of data between the server 11 and one of the electrical devices 23a and 23b is suspended.

Accordingly, if the switching unit 53 switches the switches 34 and 35 to the off state, data is not transmitted from the server 11 to the ECUs 21a, 21b, 22a, and 22b and the electrical devices 23a and 23b, and data is not transmitted from any of the ECUs 21a, 21b, 22a, and 22b and the electrical devices 23a and 23b to the server 11. For this reason, if the switching unit 53 switches the switches 34 and 35 to the off state, relaying performed by the out-of-vehicle relay device 30 is suspended.

In the relay suspend processing, after step S42 has been executed, the control unit 45 instructs the announcement unit 54 to make an announcement (step S43). The announcement unit 54 displays on the display unit a message indicating that the out-of-vehicle relay device 30 has stopped relaying, and indicating which of the determination standards J1, J2, . . . , and J7 was satisfied, for example. Accordingly, the user can become aware that an abnormality occurred in the relaying performed between the server 11 and the out-of-vehicle relay device 30.

Upon determining that relaying performed by the out-of-vehicle relay device 30 is not to be suspended (S41: NO), or after step S43 has been executed, the control unit 45 stops the relay suspend processing.

As described above, in the communication system 1, due to the control unit 56 executing the relay suspend processing, it is possible to suppress the occurrence of a problem that cannot be handled by data processing, such as the previously-described authentication, that is performed on data input to the input/output unit 40 of the out-of-vehicle relay device 30 or data output from the input/output unit 40 of the out-of-vehicle relay device 30. Examples of the aforementioned problem include the input of data for manipulating the control program P1 to the input/output unit 40, the leakage of a large amount of data, and the leakage of a specific piece of vehicle data.

### Second Embodiment

In the communication system 1 of the first embodiment, the gateway 20 and the communication device 24 are provided separately in the vehicle 12. However, the configuration of the communication system 1 is not limited to a configuration in which the gateway 20 and the communication device 24 are provided separately in the vehicle 12.

Hereinafter, differences of a second embodiment from the first embodiment will be described. Configurations of the second embodiment other than the configurations described below are the same as in the first embodiment, and therefore will be denoted by the same reference signs, thus omitting redundant descriptions.

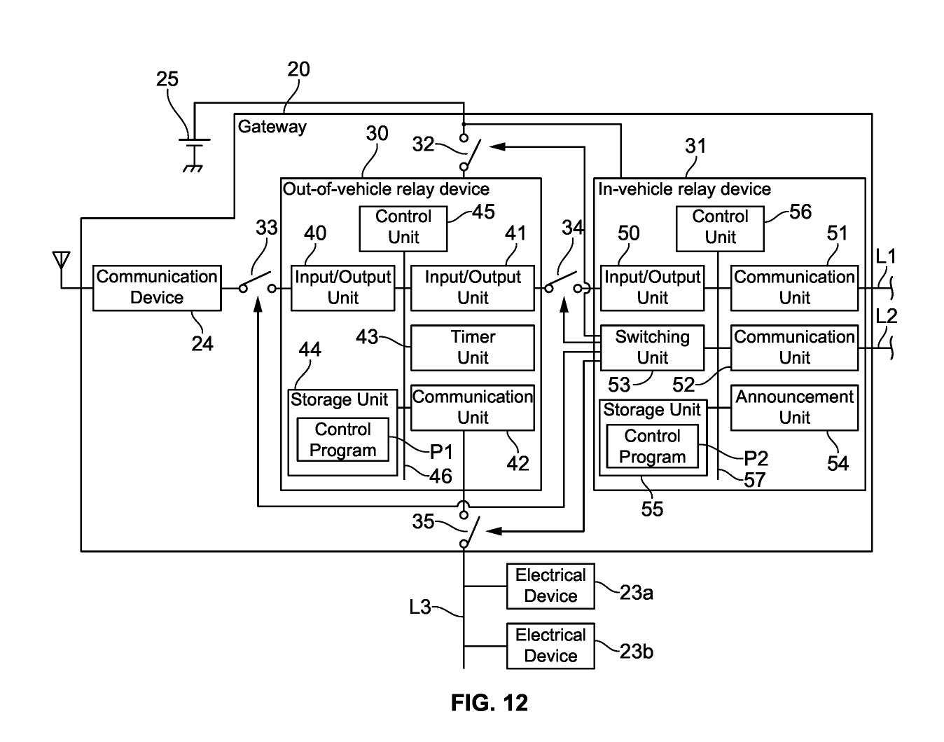

FIG. 12 is a block diagram showing the configuration of relevant portions of the gateway 20 of the second embodiment. In the communication system 1 of the second embodiment, the gateway 20 has the communication device 24 in addition to the out-of-vehicle relay device 30, the in-vehicle relay device 31, and the switches 32, 33, 34, and 35. Accordingly, in the vehicle 12, the communication device 24 is provided in the gateway 20.

The communication system 1 of the second embodiment having the above configuration achieves the same effects as the communication system 1 of the first embodiment.

### Third Embodiment

In the communication system 1 of the first embodiment, the gateway 20 has the out-of-vehicle relay device 30, the in-vehicle relay device 31, and the switches 32, 33, 34, and 35. However, the configuration of the communication system 1 is not limited to a configuration in which the out-of-vehicle relay device 30, the in-vehicle relay device 31, and the switches 32, 33, 34, and 35 are provided in the gateway 20.

Hereinafter, differences of a third embodiment from the first embodiment will be described. Configurations of the third embodiment other than the configurations described below are the same as in the first embodiment, and therefore will be denoted by the same reference signs, thus omitting redundant descriptions.

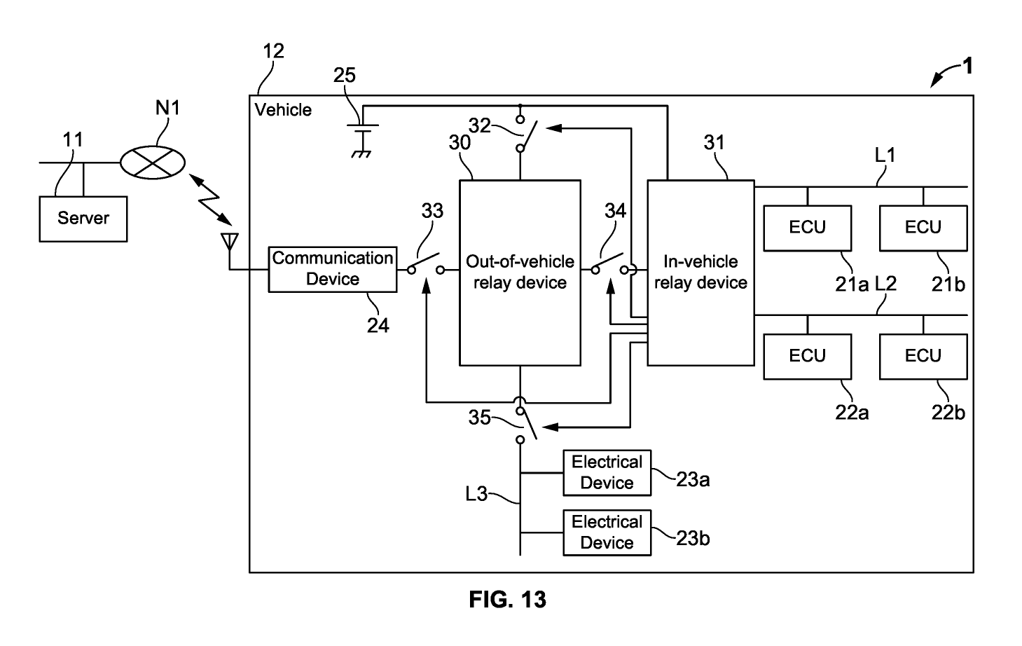

FIG. 13 is a block diagram showing the configuration of relevant portions of the communication system 1 of the third embodiment. In the communication system 1 of the third embodiment, the out-of-vehicle relay device 30, the in-vehicle relay device 31, and the switches 32, 33, 34, and 35 are not provided in the gateway 20, and are directly included in the vehicle 12.

The communication system 1 of the third embodiment having the above configuration achieves the same effects as the communication system 1 of the first embodiment.

### Fourth Embodiment

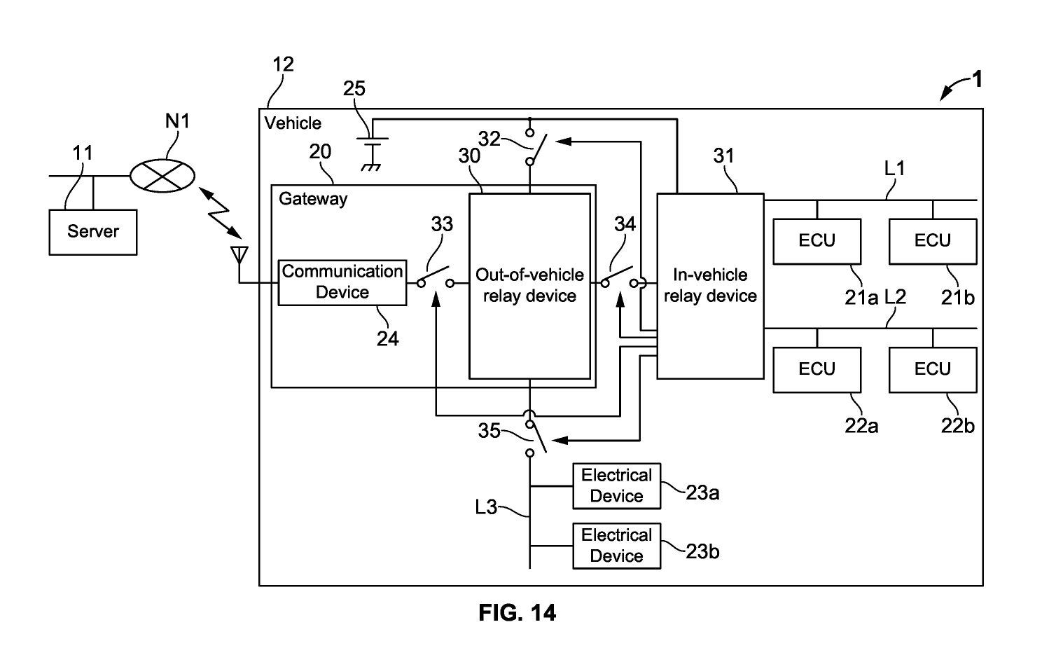

FIG. 14 is a block diagram showing the configuration of relevant portions of the communication system 1 of a fourth embodiment. Hereinafter, differences of the fourth embodiment from the first embodiment will be described. Configurations of the fourth embodiment other than the configurations described below are the same as in the first embodiment, and therefore will be denoted by the same reference signs, thus omitting redundant descriptions.

In the communication system 1 of the fourth embodiment, the communication device 24, the out-of-vehicle relay device 30, and the switch 33 are included in the gateway 20 of the vehicle 12. The in-vehicle relay device 31 and the switches 32, 34, and 35 are directly included in the vehicle 12, that is to say are provided outside of the gateway 20.

The communication system 1 of the fourth embodiment having the above configuration achieves the same effects as the communication system 1 of the first embodiment.

Note that in the first, second, third, and fourth embodiments, it is not necessarily required that the control unit 56 of the in-vehicle relay device 31 causes the switching unit 53 to switch all of the switches 32, 33, 34, and 35 from on to off in order to suspend the relaying performed by the out-of-vehicle relay device 30. If the switching unit 53 switches the switch 32 to the off state, switches the switch 33 to the off state, or switches the switches 34 and 35 to the off state, the relaying performed by the out-of-vehicle relay device 30 is suspended as previously described.

Also, the control unit 56 of the in-vehicle relay device 31 may cause the out-of-vehicle relay device 30 to suspend relaying by instructing the input/output unit 50 to output a relay suspend signal, which is for instructing the suspending of relaying, to the input/output unit 41 of the out-of-vehicle relay device 30. The control unit 56 of the in-vehicle relay device 31 may furthermore instruct an output unit (not shown) to output a transmission/reception suspend signal, which is for instructing the suspending of the transmission/reception of data with the server 11 or the out-of-vehicle relay device 30, to the communication device 24. Accordingly, the communication device 24 stops the transmission/reception of data with the server 11 or the out-of-vehicle relay device 30, and the relaying performed by the out-of-vehicle relay device 30 is suspended. In this way, the control unit 56 may suspend the out-of-vehicle relay device 30 by instructing the output unit to output a transmission/reception suspend signal to the communication device 24.

The authentication performed by the control unit 45 of the out-of-vehicle relay device 30 is not limited to authentication that employs an encryption key, and need only be authentication that enables determining whether or not received data is legitimate data.

Instead of information indicating authentication success/failure, the associated data may include information that indicates the number of times that authentication failed in a predetermined time, and/or the number of times that authentication was successful in a predetermined time. Also, the associated data may include information that indicates the amount of data that was input from the out-of-vehicle relay device 30 to the input/output unit 40 in a predetermined time, and/or the amount of data that was output from the input/output unit 40 of the out-of-vehicle relay device 30 to the communication device 24 in a predetermined time.

Moreover, the determination standards for determining whether or not relaying performed by the out-of-vehicle relay device 30 is to be suspended are not limited to the determination standards J1, J2, . . . , and J7, and may be that an authentication success ratio or failure ratio, which has the number of times authentication was performed as a parameter, is greater than or equal to a predetermined ratio, for example. Furthermore, in the case where the server 11 transmits encrypted data to the communication device 24, and the control unit 45 of the out-of-vehicle relay device 30 decrypts the data that was input from the communication device 24 to the input/output unit 40, the determination standard may be that the number of times that the decryption failed or was successful is greater than or equal to a predetermined number, or that a decryption failure ratio or success ratio is greater than or equal to a predetermined ratio. In this case, the associated data includes information regarding decryption failure or success.

Moreover, the number of determination standards is not limited to 7, and may be in the range of 1 to 6 inclusive, or greater than or equal to 8. For example, the determination standards that are used in step S41 in the relay suspend processing may be the determination standards J1, J2, and J5.

Also, the number of communication line that are connected to the in-vehicle relay device 31 is not limited to 2, and may be greater than or equal to 3. Moreover, the number of ECUs that are connected to each communication line is not limited to 2, and may be 1, or greater than or equal to 3. Furthermore, the number of electrical devices that are connected to the communication line L3 is not limited to 2, and may be 1, or greater than or equal to 3.

The first, second, third, and fourth embodiments disclosed here are to be considered in all respects as illustrative and not limiting. The scope of the present invention is indicated by the claims rather than by the foregoing description, and all changes which come within the meaning and range of equivalency of the claims are intended to be embraced therein.

1. A communication system including an internal relay device that relays data between a plurality of communication apparatuses installed in a vehicle by communicating with each of the plurality of communication apparatuses, the communication system comprising:
an external relay device that relays data between the communication apparatuses and an external apparatus that is outside the vehicle by passing data to and from the internal relay device,
wherein the external relay device has
an input unit to which data received from the external apparatus is input,
an output unit that outputs data that is to be transmitted to the external apparatus, and
a second output unit that outputs, to the internal relay device, associated data that is associated with the data that was output by the output unit, and
the internal relay device has a determination unit that determines whether or not relaying performed by the external relay device is to be suspended, based on the associated data that was output by the second output unit.

2. A communication system including an internal relay device that relays data between a plurality of communication apparatuses installed in a vehicle by communicating with each of the plurality of communication apparatuses, the communication system comprising:
an external relay device that relays data between the communication apparatuses and an external apparatus that is outside the vehicle by passing data to and from the internal relay device,
wherein the external relay device has
an input unit to which data received from the external apparatus is input,
an output unit that outputs data that is to be transmitted to the external apparatus,
a second output unit that outputs, to the internal relay device, associated data that is associated with the data that was input to the input unit, and
an authentication unit that performs authentication on the data that was input to the input unit,
the internal relay device has a determination unit that determines whether or not relaying performed by the external relay device is to be suspended, based on the associated data that was output by the second output unit,
the associated data includes information regarding failure or success of authentication performed by the authentication unit, and
the determination unit determines that the relaying is to be suspended in a case where the number of times that authentication performed by the authentication unit failed is greater than or equal to a predetermined failure count, or where the number of times that authentication performed by the authentication unit was successful is greater than or equal to a predetermined success count.

3. A communication system including an internal relay device that relays data between a plurality of communication apparatuses installed in a vehicle by communicating with each of the plurality of communication apparatuses, the communication system comprising:
an external relay device that relays data between the communication apparatuses and an external apparatus that is outside the vehicle by passing data to and from the internal relay device,
wherein the external relay device has
an input unit to which data received from the external apparatus is input,
an output unit that outputs data that is to be transmitted to the external apparatus, and
a second output unit that outputs, to the internal relay device, associated data that is associated with the data that was input to the input unit,
the internal relay device has a determination unit that determines whether or not relaying performed by the external relay device is to be suspended, based on the associated data that was output by the second output unit,
the associated data includes information regarding an amount of data that was input to the input unit, and
the determination unit determines that the relaying is to be suspended in a case where the amount of data that was input to the input unit is greater than or equal to a predetermined input data amount.

4. The communication system according to claim 1,
wherein the associated data includes information regarding an amount of data that was output by the output unit, and
the determination unit determines that the relaying is to be suspended in a case where the amount of data that was output by the output unit is greater than or equal to a predetermined output data amount.

5. The communication system according to claim 1,
wherein the associated data includes information regarding content of the data that was output by the output unit, and
the determination unit determines that the relaying is to be suspended in a case where specific data was output from the output unit.

6. The communication system according to claim 1, wherein the internal relay device has a power supply stopping unit that stops a supply of power to the external relay device in a case where the determination unit determined that the relaying performed by the external relay device is to be suspended.

7. The communication system according to claim 1, wherein the internal relay device has a prohibiting unit that prohibits inputting of data from the external apparatus to the input unit and outputting of data from the output unit to the external apparatus in a case where the determination unit determined that the relaying performed by the external relay device is to be suspended.

8. The communication system according to claim 1, wherein the external relay device relays data between the external apparatus and a second communication apparatus.
